(19) United States
(12) Patent Application Publication
(10) Pub. No.: US 2014/0198015 A1
(43) Pub. Date: Jul. 17, 2014

(54) REFLECTIVE LINE SOURCE

(71) Applicant: CMC ELECTRONIQUE INC. / CMC ELECTRONICS INC., (US)

(72) Inventors: Alan Julian Paul HNATIW, Stittsville (CA); John Patten CARR, Kanata (CA); Matthew Philip HILLS, Kanata (CA)

(73) Assignee: CMC ELECTRONIQUE INC. / CMC ELECTRONICS INC., Montreal (CA)

(21) Appl. No.: 13/743,061

(22) Filed: Jan. 16, 2013

(51) Int. Cl. H01Q 15/14; H01P 11/00

(52) U.S. Cl. CPC H01Q 15/14; H01P 11/00
USPC 343/912; 29/600

(57) ABSTRACT

There is provided a reflective line source for an antenna system. The reflective line source comprises at least one region adapted to receive an electromagnetic field and to expand the field in at least one dimension. The reflective line source further comprises a reflective phase compensator that is coupled to the region. The reflective phase compensator is adapted to correct a phase error resulting from propagation of the field through the region as well as to fold a direction of propagation of the field. For this purpose, the reflective phase compensator comprises at least two reflective phase compensating surfaces oriented at ninety degrees relative to one another.

### CROSS-REFERENCE TO RELATED APPLICATIONS

This is the first application filed for the present invention.

### TECHNICAL FIELD

The present invention relates to the field of line sources.

### BACKGROUND OF THE ART

A line source may be used in a waveguide antenna to expand a point source in one direction. Such a line source can be used as an input source to feed a larger two-dimensional aperture antenna, such as a sectoral horn. The line source may also be used solely as a line source emitter.

When used to expand an input electromagnetic field over a large frequency bandwidth, structures used to create conventional line sources typically introduce arbitrary phase errors and ohmic losses. Complex assembly is also required, making it difficult to achieve a low weight and compact size antenna, as desired for aeronautical applications and the like.

There is therefore a need for an improved line source.

### SUMMARY

In accordance with a first broad aspect, there is provided a reflective line source comprising at least one region adapted to receive thereat an input electromagnetic field and to expand the input electromagnetic field in at least one dimension and at least one reflective phase compensator coupled to the at least one region, the at least one reflective phase compensator adapted to fold a direction of propagation of the expanded electromagnetic field and correct a phase error thereof.

In accordance with a second broad aspect, there is provided a method for manufacturing a reflective line source, the method comprising providing at least one region adapted to receive thereat an input electromagnetic field and to expand the input electromagnetic field in at least one dimension and coupling at least one reflective phase compensator to the at least one region, the at least one reflective phase compensator adapted to fold a direction of propagation of the expanded electromagnetic field and correct a phase error thereof.

### BRIEF DESCRIPTION OF THE DRAWINGS

Further features and advantages of the present invention will become apparent from the following detailed description, taken in combination with the appended drawings, in which:

FIG. 1 is a perspective view of a folded reflective line source in accordance with an illustrative embodiment of the present invention;

FIG. 2a is a schematic diagram of a taper region of FIG. 1;

FIG. 2b is a bottom view of the folded reflective line source of FIG. 1;

FIG. 2c is a schematic diagram of a reflective phase compensator of FIG. 1;

FIG. 3a is a perspective cross-sectional view of the folded reflective line source of FIG. 1;

FIG. 3b is a perspective view of the folded reflective line source of FIG. 1 with an input beam propagating through a first taper region;

FIG. 3c is a schematic diagram of a reflector of FIG. 3a;

FIG. 3d is a perspective view of the folded reflective line source with the input electromagnetic field of FIG. 3b propagating through the first and a second taper region;

FIG. 3e is a perspective view of the folded reflective line source with the input electromagnetic field of FIG. 3b propagating through a second, a third and a fourth taper region;

FIG. 4a is a plot of the phase error for the folded reflective line source of FIG. 1 prior to compensation using the reflective phase compensator;

FIG. 4b is a plot of the phase error for the folded reflective line source of FIG. 1 after compensation;

FIG. 5a is a bottom perspective view of a folded reflective line source integrated with an E-plane sectoral horn in accordance with an illustrative embodiment of the present invention;

FIG. 5b is a front perspective view of the folded reflective line source integrated with the E-plane sectoral horn of FIG. 5a;

FIG. 6 is a plot of modeled and measured results of the azimuth far field gain pattern for the folded reflective line source integrated with the E-plane sectoral horn of FIG. 5a; and

FIG. 7 is a flow diagram of a method for manufacturing a folded reflective line source in accordance with an illustrative embodiment of the present invention.

It will be noted that throughout the appended drawings, like features are identified by like reference numerals.

### DETAILED DESCRIPTION

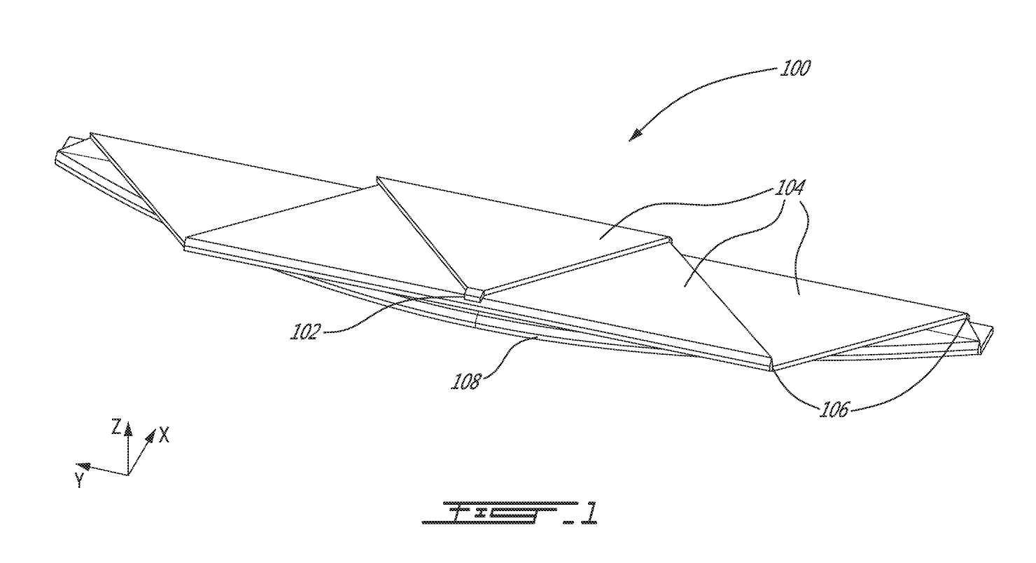

Referring to FIG. 1, a folded reflective line source 100 in accordance with an illustrative embodiment will now be described. As will be discussed further below, the line source 100 may be used to expand in one direction, e.g. the X direction, a point source fed thereto. As such, the line source 100 may be used as an input source to feed an antenna (not shown), such as an aperture antenna, e.g. a horn, waveguide aperture, reflector, or the like, that emits electromagnetic waves through an opening or aperture. The line source 100 illustrative comprises an input 102, a plurality of expansion regions 104 used to guide therethrough an electromagnetic field received at the input 102, a plurality of 180 degrees elongate reflectors 106 used to fold the direction of propagation of the field by 180 degrees, and a reflective phase compensator 108.

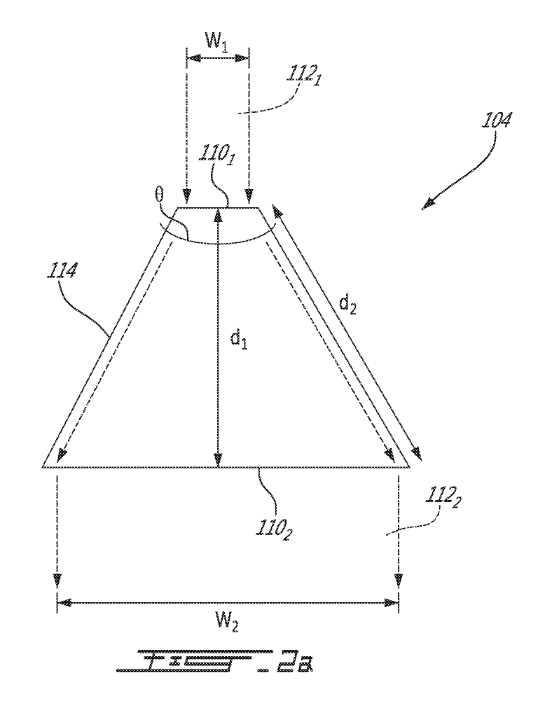

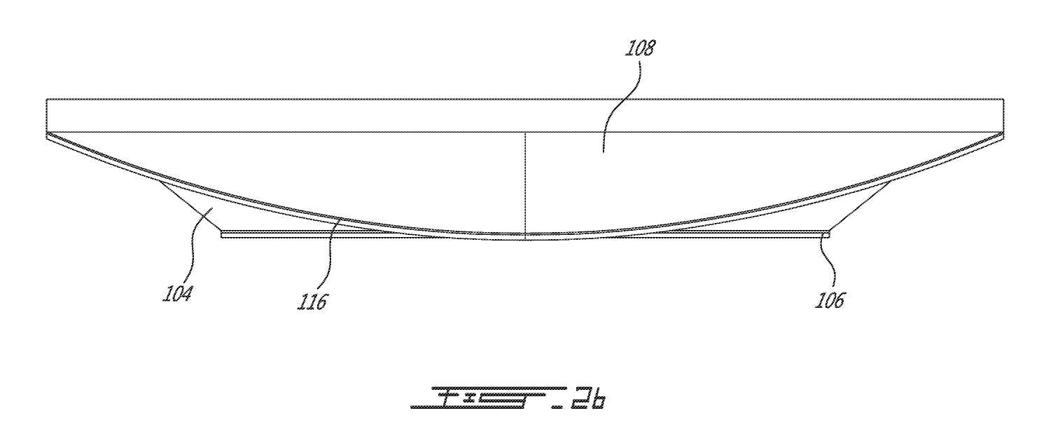

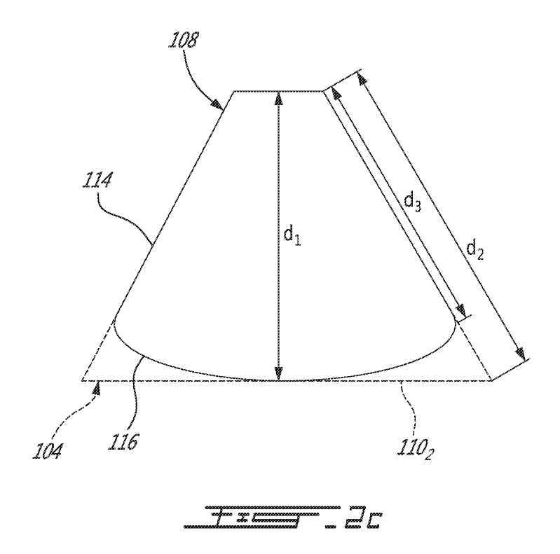

In particular, as illustrated in FIG. 2a, in some embodiments, each expansion region 104 flares away from a first edge 110₁ towards a second edge 110₂ opposite to the first edge 110₁. In this manner, a field 112₁ that has a width w₁ and enters the expansion region 104 at the first edge 110₁ is expanded when propagating down the expansion region 104 towards the second edge. As such, the width w₂ of the field 112₂ exiting the expansion region 104 is illustratively greater than the width w₁ of the field 112₁ entering the expansion region 104. The flare angle θ may be adjusted to achieve the desired flare in the expansion region 104. By increasing the flare angle θ, the rate of flare of the expansion region 104 may be increased, resulting in a faster expansion of the input electromagnetic field 112₁. The flare angle θ of the expansion regions 104 is illustratively comprised between zero and ninety (90) degrees. In one embodiment, one expansion region 104, and more particularly the last expansion region through which the field exits the line source 100, is a straight region that is provided with no taper.

In addition to expanding the field 112₁, propagation down each tapered one of the expansion regions 104 introduces a phase error between the field 112₁ entering the tapered expansion region 104 and the field 112₂ exiting the tapered expansion region 104. Indeed, the difference between the length d₁ from the center point of the first edge 110₁ of the tapered expansion region 104 to the center point of the second edge 110₂ and the length d₂ along each one of the side edges as in 114 of the tapered expansion region 104 results in a difference between the phase of the field 112₁ and the phase of the field 112₂. In particular, the length d₂ is substantially greater than the length d₁. It should be understood that the greater the flare angle θ of each expansion region 104, the greater the phase error and the higher the need for phase compensation. Indeed, a gentle width expansion would likely not require phase correction. Still, such a gentle expansion would result in the line source as in 100 being several meters in length so as to achieve a half-meter wide output field. In order to ensure the compactness of the line source 100, it is therefore desirable for the width expansion to be rapid and accordingly for phase compensation to be implemented using the reflective phase compensator 108. Although the expansion region 104 has been illustrated in FIG. 2a as comprising side edges 114, e.g. metal walls, it should be understood that the expansion regions 104 may be provided without such edges 104.

Referring now to FIG. 2b and FIG. 2c, the reflective phase compensator 108 may be used to compensate for the above-mentioned phase error. For this purpose, the phase compensator 108 may be provided to couple a pair of consecutive expansion regions as in 104 of the line source 100. In the embodiment illustrated in FIG. 2b, the phase compensator 108 is provided at the end of the second to last expansion region 104. Still, it should be understood that the phase compensator 108 may be provided at the end of any tapered one of the expansion regions 104 and thus may couple any pair of consecutive expansion regions 104. In such cases, the phase compensator 108 may be designed to overcompensate the phase error. In this manner, although the electromagnetic field exiting the phase compensator 108 will propagate through the remaining expansion regions 104, thereby introducing additional phase error, the overcompensation initially effected by the phase compensator 108 illustratively results in an overall phase error cancellation. It should further be understood that multiple phase compensators 108 may be provided for coupling to more than one pair of expansion regions 104.

The reflective phase compensator 108 illustratively has an arcuate profile and comprises an arcuate edge 116. The complex shape of the reflective phase compensator 108 illustratively introduces a complex phase correction factor, i.e. a non-uniform phase. It should be understood that the reflective phase compensator 108 may have a simple conic profile, may be of high order aspherical type, or any other suitable profile known to those skilled in the art. For example, the phase compensator 108 may be shaped as an arc of circle, a conic section, a polynomial surface, a parabola, or the like. It should also be understood that the shape of the phase compensator 108 may or may not be smooth continuous. For instance, the phase compensator 108 may have a discontinuous curvature, be piecewise arcuate, or otherwise segmented. Other profiles may also apply.

As shown in FIG. 2c, when an expansion region 104 is provided with such a phase compensator 108 having the arcuate edge 116, the length along each one of the side edges 114 of the expansion region 104 is illustratively reduced from the value d₂ to the value d₃, with the length d₁ along the center line (not shown) of the expansion region 104 being longer than the length d₃ along the edges 114 thereof. Thus, the difference between the lengths d₁ and d₃ may be reduced, resulting in a compensation of the phase error.

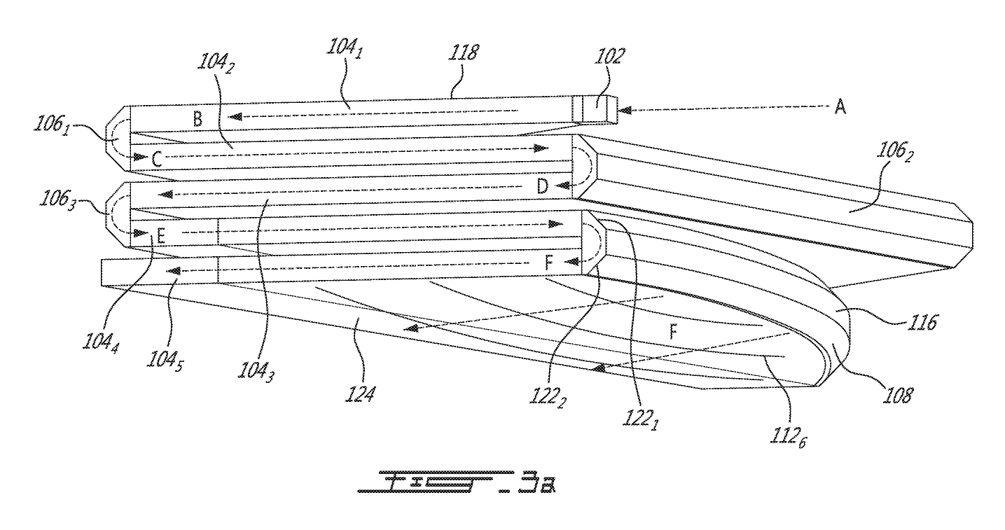

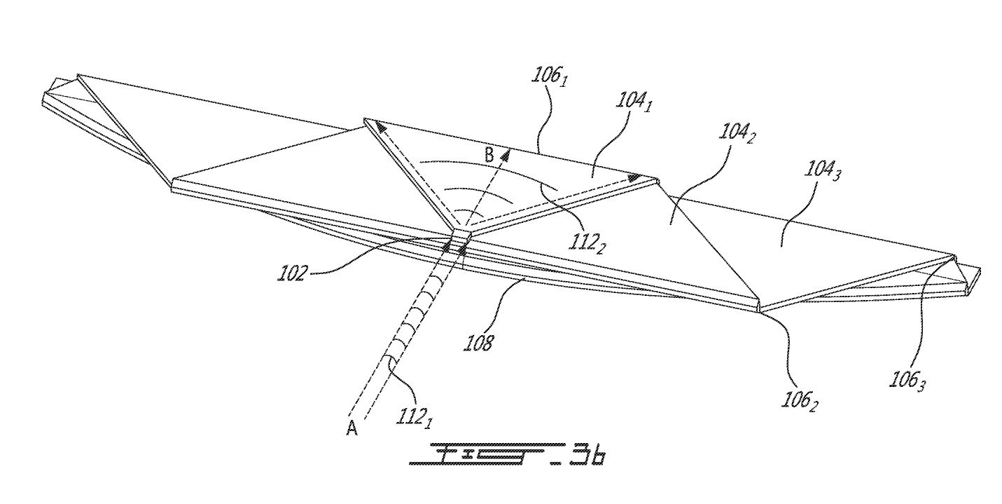

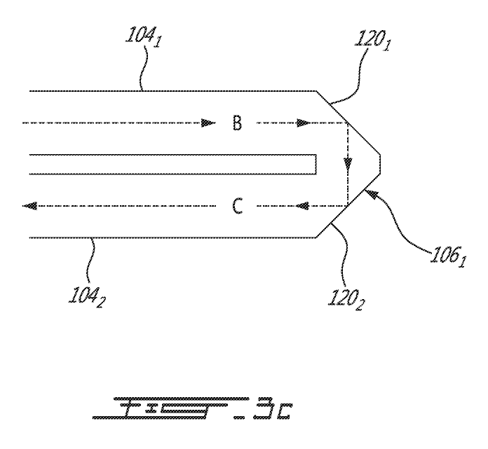

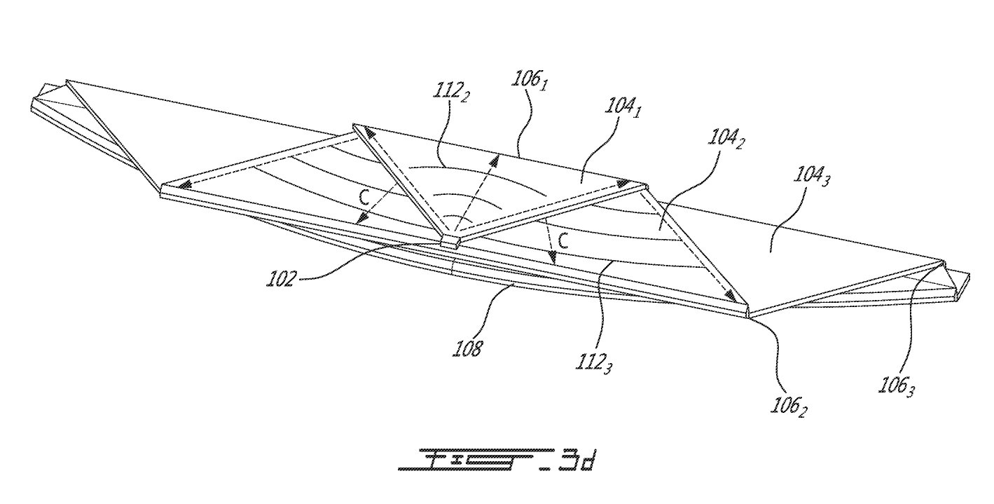

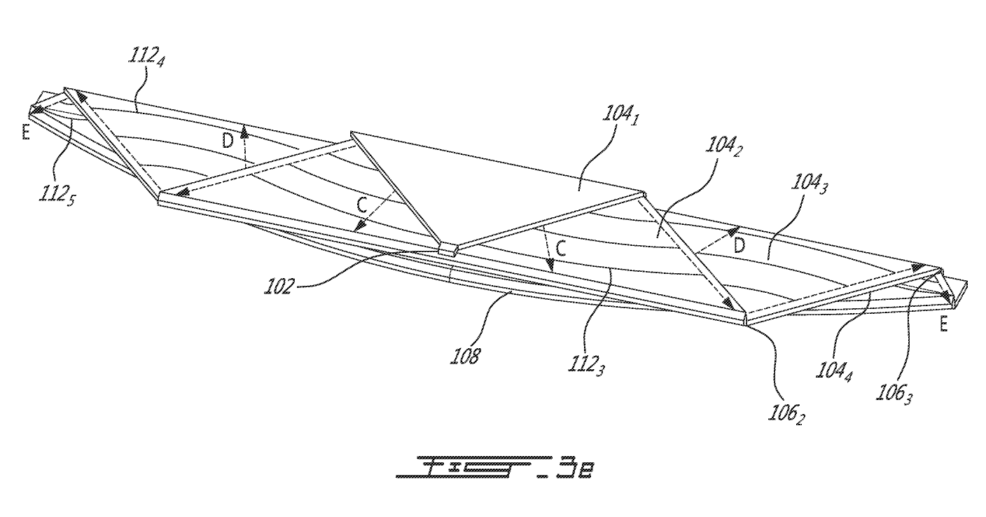

Referring now to FIG. 3a in addition to FIG. 2a, in one embodiment, the reflective line source 100 may comprise five (5) connected expansion regions 104₁, 104₂, 104₃, 104₄, and 104₅. It should be understood that any suitable number of expansion regions may also apply. The expansion regions 104₁, 104₂, 104₃, 104₄, and 104₅ may be provided in a vertically, i.e. along the Z direction, stacked relationship and connected by the elongate reflectors 106 to create a compact folded structure. In particular, a first expansion region, as in 104₁, and a second expansion region, as in 104₂, are connected such that a first reflector, as in 106₁, is provided between the second edge 110₂ of the first expansion region and the first edge 110₁ of the second expansion region. In addition, in the embodiment of FIG. 3a, expansion regions 104₁, 104₂, 104₃, and 104₄ are illustratively tapered waveguides with a flare angle θ while the fifth expansion region 104₅ through which the electromagnetic field exits the line source 100 is a straight waveguide, i.e. is not tapered. It should be understood that other configurations may apply. As the width of the electromagnetic field exiting each one of the tapered expansion regions 104₁, 104₂, 104₃, and 104₄ is illustratively expanded compared to the field received at the input 102, the tapered expansion regions 104₁, 104₂, 104₃, and 104₄ illustratively have an increasing size. Indeed, the width w2 of the second edge 110₂ of a first tapered expansion region, as in 104₁, is illustratively equal to the width w1 of the first edge 110₁ of the tapered expansion region, as in 104₂, which is connected and consecutive to the first tapered expansion region, as in 104₁.

Referring to FIG. 3b in addition to FIG. 3a, a guided electromagnetic field 112₁ illustratively enters the line source 100 at the input 102 along a direction A. The field 112₁ then travels along a direction B through the first expansion region 104₁ found on the top layer 118 of the line source 100. While traveling through the first expansion region 104₁, the field 112₁ gets expanded into a field 112₂. At the end of the first expansion region 104₁, the first reflector 106₁ redirects the expanded field 112₂ into the second expansion region 104₂ found below the top layer 118. For this purpose, and as illustrated in FIG. 3c, the reflector 106₁ illustratively comprises a first angled facet 120₁ and a second angled facet 120₂. The first and the second angled facets 120₁ and 120₂ illustratively act as reflective surfaces oriented at forty-five (45) degrees to the incident field. As such, the field 112₂ incoming along the direction B is illustratively turned through 90 degrees by each one of the first angled facet 120₁ and the second angled facet 120₂. Thus, the field 112₃ exiting the first reflector 106₁ into the second expansion region 104₂ along direction C is illustratively turned by 180 degrees by the pair of angled facets 120₁ and 120₂, as illustrated in FIG. 3d. It should be understood that the first reflector 106₁ may comprise more than two angled facets as in 120₁ and 120₂ and that the angled facets 120₁ and 120₂ may be oriented at angles other than forty-five (45) degrees. Still, regardless of the design of the first reflector 106₁ and remaining ones of the reflectors as in 106, it is desirable for the incoming field to be reflected by 180 degrees.

Referring to FIG. 3e, the field 112₃ may then continue to travel down the second expansion region 104₂ of the reflective line source 100 along the direction C. The field 112₃ may get redirected by a second reflector 106₂ found at the end of the second expansion region 104₂. The second reflector 106₂ illustratively comprises a first and a second angled facet similar to the facets 120₁ and 120₂ of the first reflector 106₁ of FIG. 3c. As such, the field 112₄ exiting the second reflector 106₂ is illustratively turned by 180 degrees upon entering into the third expansion region 104₃ along the direction D. When so redirected, the field 112₄ travels through the third expansion region 104₃ towards the end thereof. The field 112₄ may then be redirected as a field 112₅ towards the fourth expansion region 104₄ by a third 180 degree reflector 106₃ comprising angled facets similar to the facets 120₁ and 120₂ of the first reflector 106₁.

Referring back to FIG. 3a in addition to FIG. 3e, the field 112₅ may then travel through the fourth expansion region 104₄ along the direction E. When traveling through the fourth expansion region 104₄, the field 112₅ may further encounter the reflective phase compensator 108, which illustratively corrects errors induced by the finite length tapered expansion regions as in 104₁, 104₂, 104₃, 104₄. In particular and as discussed above with reference to FIG. 2c, upon reaching the arcuate edge 116, the field 112₅ has illustratively traveled through an expansion region 104₄ where the length (reference d₁ in FIG. 2c) along the center line is longer than the length (reference d₂ in FIG. 2c) along the edges (reference 114 in FIG. 2c). As such, it is desirable, using the reflective phase compensator 108, to achieve phase compensation for the distances traveled by the signal through the expansion regions 104₁, 104₂, 104₃, and 104₄. In particular, the phase compensator 108 may correct the phase error so that a planar phase front is achieved at an output of the line source 100. The phase compensator may alternatively correct the phase error so that a target value phase front is achieved.

The arcuate edge 116 illustratively comprises a first and a second reflective phase compensating surface 122₁ and 122₂. In one embodiment, the reflective phase compensating surfaces 122₁ and 122₂ are arcuate angled facets each oriented at substantially forty-five (45) degrees for turning an electromagnetic field impinging thereon by substantially ninety (90) degrees. It should be understood that the phase compensator 108 may comprise more than two reflective phase compensating surfaces 122₁ and 122₂ and that the latter may be oriented at angles other than forty-five (45) degrees. Upon reaching the arcuate edge 116, the field 112₅ thus successively encounters the first and the second reflective phase compensating surfaces 122₁ and 122₂. As such, the field 112₅ is folded by 180 degrees and redirected towards the fifth expansion region 104₅ found on the bottom layer 124 of the folded structure 100. The field 112₆ exiting the reflective phase compensator 108 may then propagate along the direction F through the fifth expansion region 104₅.

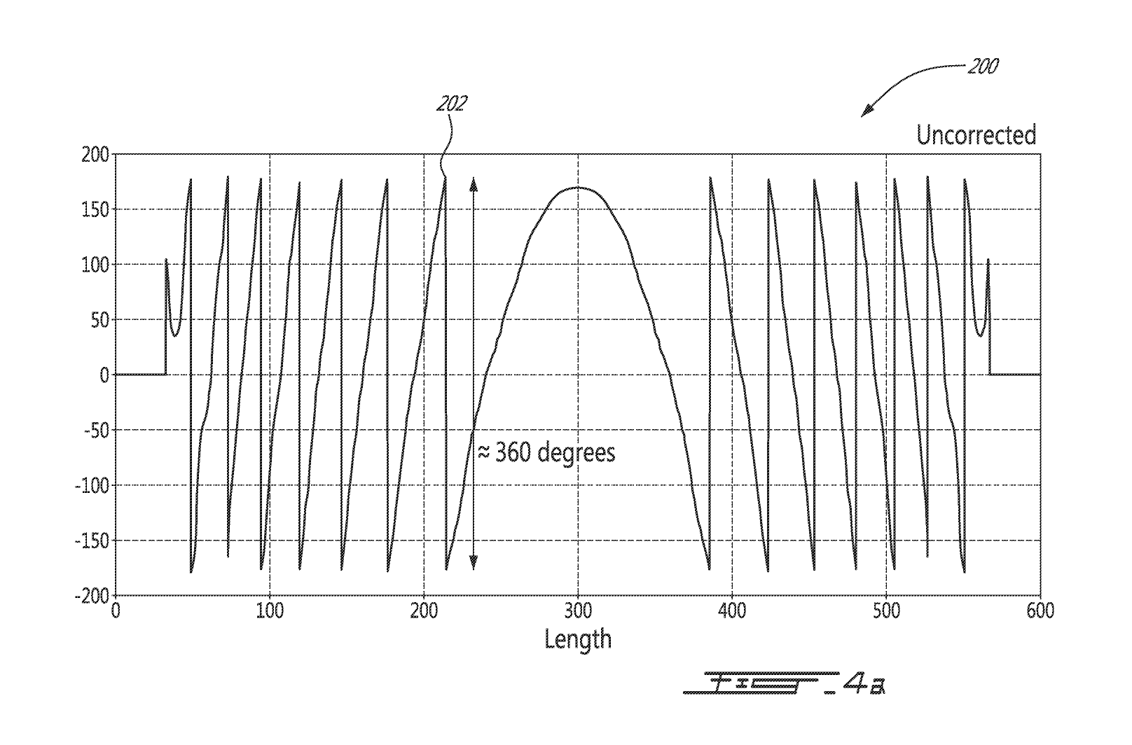

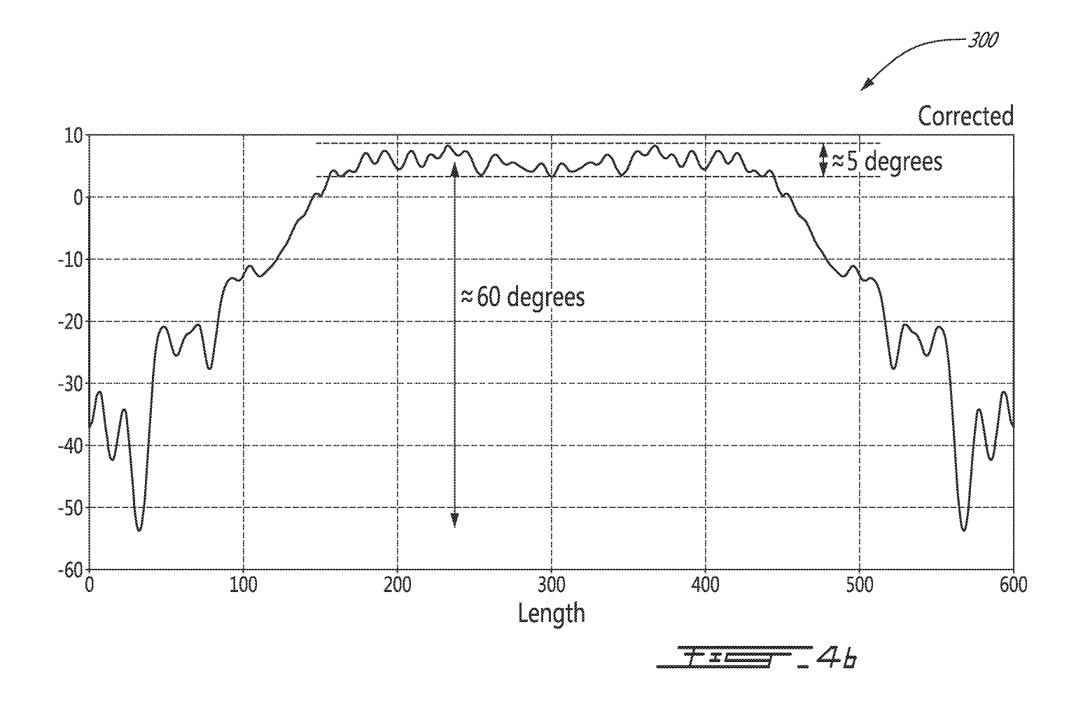

FIG. 4a and FIG. 4b illustrate results obtained by simulating a 600 mm by 700 mm reflective line source (reference 100 in FIG. 1). Such a line source 100 is then used as an input source to feed an antenna (not shown). Simulations were performed using electromagnetic simulation software, such as CST Microwave Studio™. It should be understood that any other suitable software known to those skilled in the art may be used. FIG. 4a shows a plot 200 of the phase error in the reflective line source 100 without phase error compensation. Due to the periodic nature of electromagnetic waves, phase jumps 202 of substantially 360 degrees occur due to phase wrapping. The unwrapped total phase error of the uncompensated expansion regions (reference 104 in FIG. 1) is in excess of 2600 degrees or approximately 7.2 wavelengths.

FIG. 4b shows a plot 300 of the phase error after compensation using a reflective phase compensator (reference 108 in FIG. 1). After the field propagates through the reflective phase compensator 108, a non-uniform and complex phase correction factor is introduced. As a result, the peak-to-peak phase error is reduced to less than five (5) degrees over half of the width of the antenna aperture. The phase correction factor being non-uniform, a residual phase error remains across the full width of the antenna aperture. Still, this phase error is reduced to approximately sixty (60) degrees or 0.17 wavelengths. A phase error less than one-quarter of a wavelength can therefore be achieved using the reflective line source architecture 100 described above. As known to those skilled in the art, a phase error of lambda/6, with lambda being the wavelength of the electromagnetic wave, or sixty (60) degrees is typically sufficient for most antenna applications.

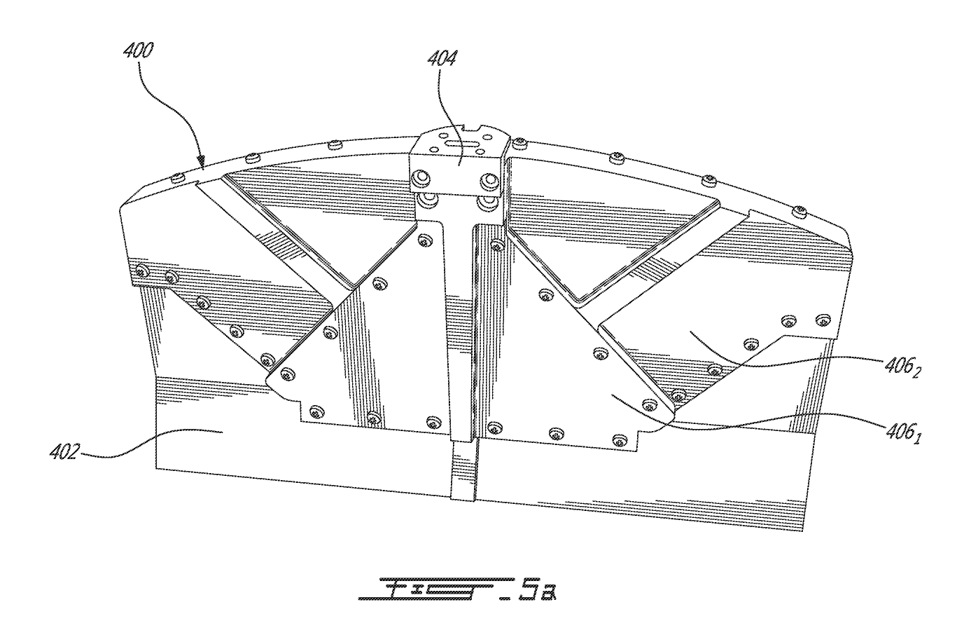

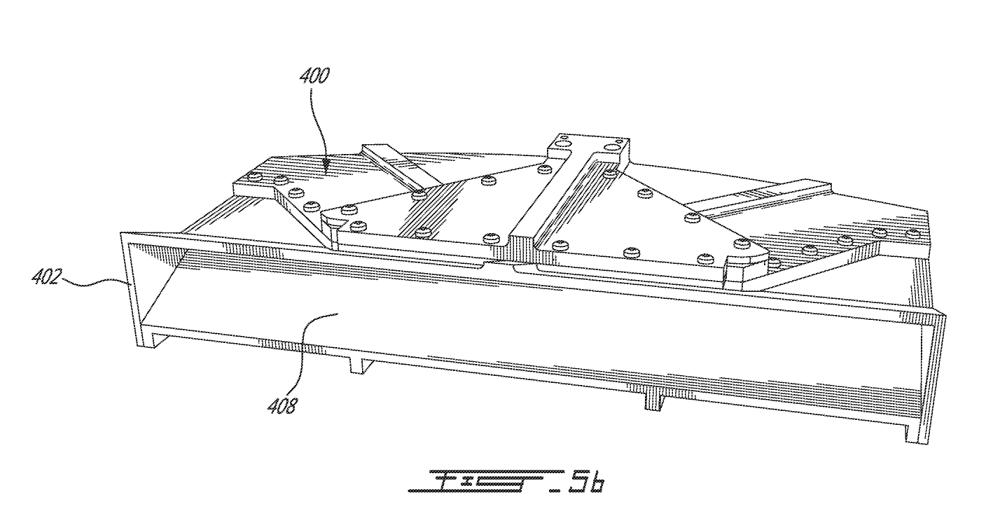

As discussed above, the reflective line source 100 may be coupled to a plurality of antenna types. FIG. 5a and FIG. 5b show a proof-of-concept reflective line source 400 integrated with an E-plane sectoral horn 402. The proof-of-concept line source 400 and the sectoral horn 402 may be fabricated using any suitable manufacturing process, such as rapid prototyping. The rapid prototyping process illustratively uses a laser to cure polymer into a specific geometry. In the embodiment shown in FIG. 5a and FIG. 5b, the resulting polymer part is then metalized with copper. An input waveguide 404 as well as two (2) expansion regions 406₁ and 406₂ of the line source 400 can be seen in FIG. 5a. FIG. 5b shows the output radiator 408 of the sectoral horn 402 with the line source 100 attached on top and to the back of the horn 402.

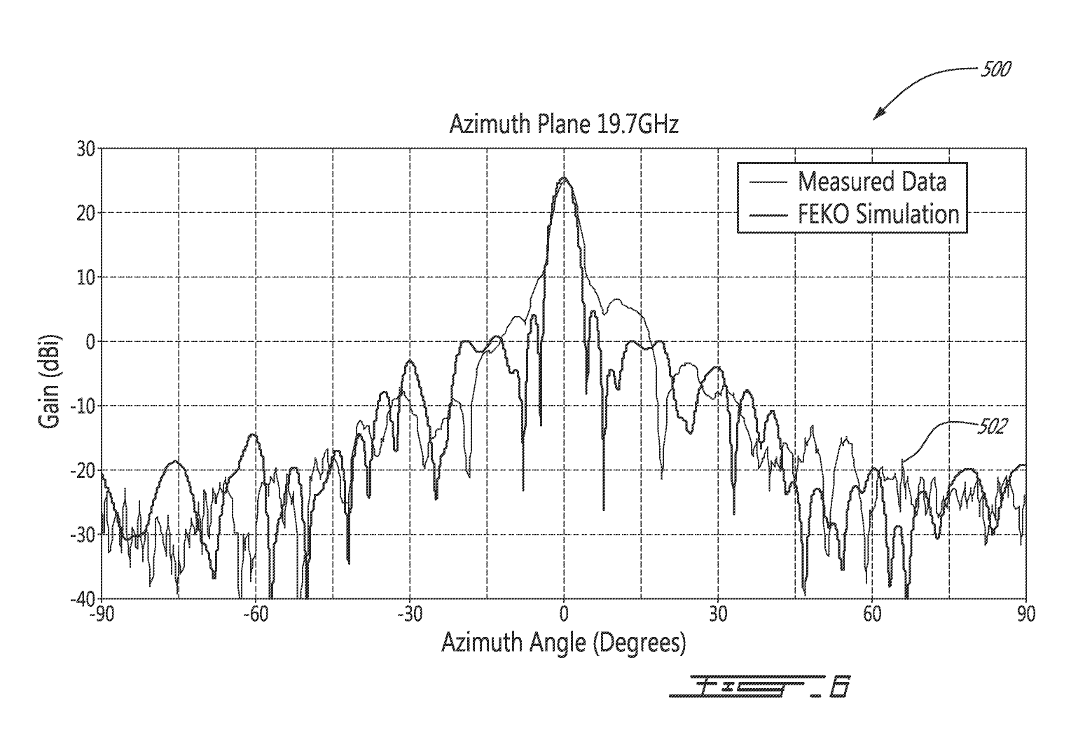

FIG. 6 illustrates a comparison between modeled and measured results of the azimuth far field gain pattern at 19.7 GHz for the folded reflective line source 400 and E-plane sectoral horn 402 of FIG. 5a and FIG. 5b. The gain pattern plot 500 shows the agreement of the integration of the line source 400 with the sectoral horn 402. Indeed, well-behaved and low sidelobe levels 502 are obtained due to the fact that the phase error is reduced to less than one-quarter of a wavelength using the reflective phase compensator (reference 108 in FIG. 1).

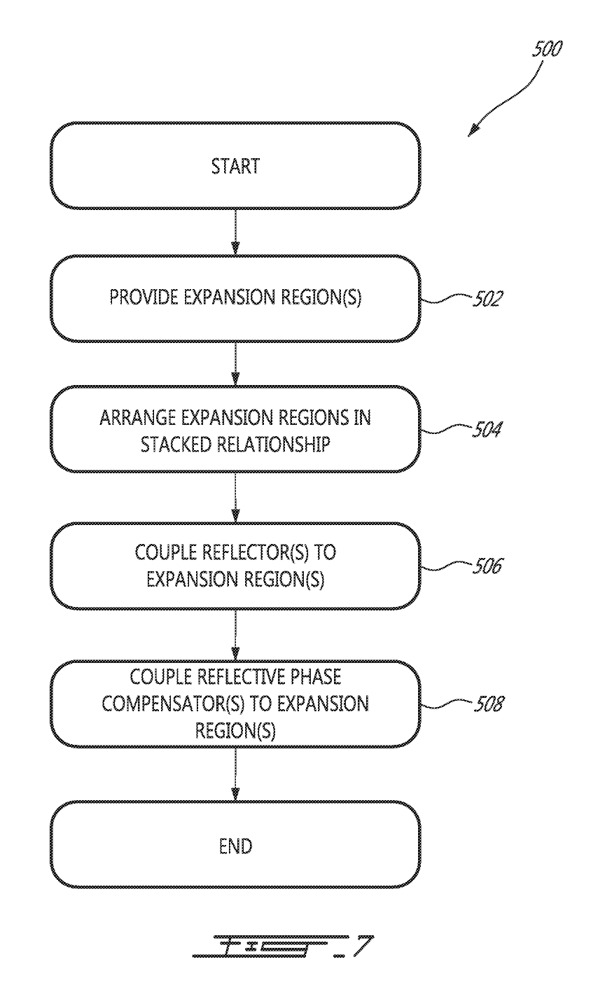

Referring to FIG. 7, a method 500 for manufacturing a folded reflective line source, such as the line source 100 of FIG. 1, will now be described. The method 500 comprises providing at step 502 one or more expansion regions (reference 104 in FIG. 1). As described above, each expansion region may be such that an input field may be received at a first end thereof and an output field output through a second end thereof opposite the first end. When a plurality of expansion regions are provided, the next step 504 may then comprise arranging the expansion regions in a vertically stacked relationship. In particular, the expansion regions may be arranged such that the second end of each expansion region is adjacent the first end of the consecutive expansion region.

When a plurality of expansion regions are provided, the method 500 may then comprise coupling at step 506 a reflector (reference 106 in FIG. 1) to each consecutive pair of expansion regions. In particular, the step 506 may comprise, as discussed above, coupling the reflector between the second end of the first expansion region of each pair and the first end of the second expansion region of the pair. In this manner, any electromagnetic field exiting through the second end of the first expansion region of each pair may be redirected towards the first end of the second expansion region of the pair, thereby connecting the expansion regions. The step 506 may, for instance, comprise providing a reflector having a first and a second angled facet each oriented at forty-five (45) degrees to an incident electromagnetic field for folding the direction of propagation of a field incident on the reflector by 180 degrees.

The next step 508 may then be to couple at least one reflective phase compensator (reference 108 in FIG. 1) to at least one of the expansion regions. It should be understood that the order of steps 506 and 508 may be interchanged. The phase compensator may be coupled to the second end of a first expansion region and the first end of the second expansion region consecutive to the first expansion region. The phase compensator may be provided with an arcuate or other suitable shape for compensating a phase error due to propagation of a field through the taper regions connected at step 506. In particular, the phase compensator coupled at step 508 to the expansion region(s) may be provided with at least two reflective phase compensating surfaces for folding by 180 degrees a field incident on the phase compensator.

Referring back to FIG. 1, the folded reflective line source architecture illustratively compensates for arbitrary phase errors over a very large frequency bandwidth. In particular, broadband response over 50% of the bandwidth may be achieved and the design may be scalable from 5 GHz to 75 GHz operating frequency. The line source 100 may further allow for superior phase control and provide continuous and smooth phase responses as well as a symmetric and well controlled phase and amplitude field distribution. Moreover, a reduction of losses and a loosening of assembly tolerances may be achieved. Also, the reflective line source 100 illustratively enables a compactness and a reduction in the weight of the overall antenna structure. The design may further be compatible with conventional high speed machining, extrusion, injection molding, arc-machining, stamping, or other manufacturing processes known to those skilled in the art.

The embodiments of the invention described above are intended to be exemplary only. The scope of the invention is therefore intended to be limited solely by the scope of the appended claims.

1. A reflective line source comprising:
at least one region adapted to receive thereat an input electromagnetic field and to expand the input electromagnetic field in at least one dimension; and
at least one reflective phase compensator coupled to the at least one region, the at least one reflective phase compensator adapted to fold a direction of propagation of the expanded electromagnetic field and correct a phase error thereof.

2. The line source of claim 1, wherein the at least one reflective phase compensator comprises at least a first reflective phase compensating surface and a second reflective phase compensating surface, the second reflective phase compensating surface oriented at substantially ninety degrees to the first reflective phase compensating surface for folding the direction of propagation of the expanded electromagnetic field by substantially 180 degrees.

3. The line source of claim 1, wherein the at least one region has a first end adapted to receive thereat the input electromagnetic field and a second end opposite to the first end and adapted to output therethrough the expanded electromagnetic field, a first width of the input electromagnetic field smaller than a second width of the expanded electromagnetic field.

4. The line source of claim 3, wherein the at least one region comprises a plurality of regions arranged in a vertically stacked relationship with the second end of each region positioned adjacent to the first end of a consecutive region.

5. The line source of claim 4, wherein the at least one reflective phase compensator couples the second end of a first one of the plurality of regions to the first end of a second one of the plurality of regions consecutive to the first region for redirecting a first electromagnetic field output at the second end of the first region towards the first end of the second region.

6. The line source of claim 5, further comprising a plurality of reflectors coupled to remaining ones of the plurality of regions, each reflector coupling the second end of a first one of the remaining regions to the first end of a second one of the remaining regions, the second remaining region consecutive to the first remaining region.

7. The line source of claim 6, wherein each one of the plurality of reflectors comprises a first angled facet positioned adjacent to the second end of the first remaining region and a second angled facet oriented at substantially ninety degrees to the first angled facet and positioned adjacent to the first end of the second remaining region for redirecting a second electromagnetic field output at the second end of the first remaining region towards the first end of the second remaining region.

8. The line source of claim 4, wherein a first one of the plurality of regions is adapted to receive the input electromagnetic field and a last one of the plurality of regions is adapted to output an output electromagnetic field, and further wherein the last region is straight while remaining ones of the plurality of regions are each tapered with a flare angle comprised between zero and ninety degrees.

9. The line source of claim 1, wherein the at least one reflective phase compensator corrects the phase error to achieve one of a planar phase front and a target value phase front.

10. The line source of claim 1, wherein the at least one phase compensator has a profile selected from the group consisting of an arc of circle, a conic section, a parabola, a polynomial surface, a high order aspherical shape, a discontinuous curvature, and a piecewise arcuate shape.

11. The line source of claim 10, wherein the profile of the at least one phase compensator introduces a non-uniform phase correction factor for correcting the phase error.

12. A method for manufacturing a reflective line source, the method comprising:
providing at least one region adapted to receive thereat an input electromagnetic field and to expand the input electromagnetic field in at least one dimension; and
coupling at least one reflective phase compensator to the at least one region, the at least one reflective phase compensator adapted to fold a direction of propagation of the expanded electromagnetic field and correct a phase error thereof.

13. The method of claim 12, wherein coupling the at least one reflective phase compensator to the at least one region comprises coupling at least a first reflective phase compensating surface and a second reflective phase compensating surface to the at least one region, the second reflective phase compensating surface oriented at substantially ninety degrees to the first reflective phase compensating surface for folding the direction of propagation of the expanded electromagnetic field by substantially 180 degrees.

14. The method of claim 12, wherein providing the at least one region comprises providing the at least one region having a first end adapted to receive thereat the input electromagnetic field and a second end opposite to the first end and adapted to output therethrough the expanded electromagnetic field, a first width of the input electromagnetic field smaller than a second width of the expanded electromagnetic field.

15. The method of claim 14, wherein providing the at least one region comprises arranging a plurality of regions in a vertically stacked relationship with the second end of each region positioned adjacent to the first end of a consecutive region.

16. The method of claim 15, wherein coupling the at least one reflective phase compensator to the at least one region comprises coupling the at least one reflective phase compensator between the second end of a first one of the plurality of regions and the first end of a second one of the plurality of regions consecutive to the first region for redirecting a first electromagnetic field output at the second end of the first region towards the first end of the second region.

17. The method of claim 16, further comprising coupling a plurality of reflectors to remaining ones of the plurality of regions, each reflector coupling the second end of a first one of the remaining regions to the first end of a second one of the remaining regions, the second remaining region consecutive to the first remaining region.

18. The method of claim 17, wherein coupling a plurality of reflectors comprises positioning a first angled facet of each one of the plurality of reflectors adjacent to the second end of the first remaining region and positioning a second angled facet of the reflector adjacent to the first end of the second remaining region, the second angled facet oriented at substantially ninety degrees to the first angled facet for redirecting a second electromagnetic field output at the second end of the first remaining region towards the first end of the second remaining region.

19. The method of claim 15, wherein providing the at least one region comprises providing a first one of the plurality of regions for receiving the input electromagnetic field and a last one of the plurality of regions for outputting an output electromagnetic field, the last region being straight while remaining ones of the plurality of regions are each tapered with a flare angle comprised between zero and ninety degrees
